(19) United States
(12) Patent Application Publication
(10) Pub. No.: US 2006/0205392 A1
(43) Pub. Date: Sep. 14, 2006

(54) System and method for using multiple calls to provide feature support in a handoff environment

(75) Inventors: Ramanathan T. Jagadeesan, San Jose, CA (US); Bich T. Nguyen, Los Altos, CA (US); David R. Daiker, Chapel Hill, NC (US); James David Williams, Cary, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/076,388

(22) Filed: Mar. 8, 2005

(51) Int. Cl. H04M 3/42

(52) U.S. Cl. 455/414.1

(57) ABSTRACT

A method for providing feature support is provided that includes receiving, by a mobile station, multiple cell calls and coordinating media associated with the cell calls in order to make a feature of the mobile station functional for an end user of the mobile station. The feature is invoked after the mobile station has roamed from an enterprise network to a cellular network and experienced a handoff.

### TECHNICAL FIELD OF THE INVENTION

The present invention relates generally to network communications and, more particularly, to a system and a method for using multiple calls to provide feature support in a handoff environment.

### BACKGROUND OF THE INVENTION

Networking architectures have grown increasingly complex in communications environments. In recent years, a series of protocols and architectures have been developed in order to accommodate a diverse group of end users having various needs. Some of these protocols relate to issues associated with handoffs.

As both public and private network systems grow in size and in sophistication, proper routing and efficient management of communication sessions and data flows becomes even more critical. In cases where protocols are unable to accommodate a given service or feature, an end user is precluded from enjoying the benefits of a given communication architecture. Advances in technology have resulted in the deployment of various types of wireless networks. However, while most of these wireless networks often provide service to adjacent and/or overlapping physical spaces, most cellular and enterprise network protocols are incompatible. Accordingly, the ability to provide an effective mechanism to properly process and direct communications for an end user seeking to realize the benefits provided by multiple network environments offers a significant challenge to network operators, component manufacturers, and system designers.

### SUMMARY OF THE INVENTION

In accordance with some of the teachings of the present invention, techniques for providing optimal feature support in the context of an effective handoff between circuit-switched cellular and packet-switched wireless networks are provided. According to some embodiments, these techniques enable a mobile station to maintain a communication session that is switched between circuit-switched cellular and packet-switched wireless networks while enjoying any given phone feature. In particular, these techniques can enable a mobile station, alone or in combination with a mobility application, to coordinate multiple calls to achieve the features invoked by the end user.

According to a particular embodiment, a method for providing feature support is provided that includes receiving, by a mobile station, multiple cell calls and coordinating media associated with the cell calls in order to make a feature of the mobile station functional for an end user of the mobile station. The feature is invoked after the mobile station has roamed from an enterprise network to a cellular network and experienced a handoff.

In more particular embodiments, the method includes: if any of the calls are terminated, the mobile station is immediately made aware of the termination. Additionally, the method may include communicating with a mobility application to achieve the handoff and communicating a call ID to the mobility application to uniquely distinguish a second call from a first call, which was an original call for the mobile station.

Embodiments of the invention provide various technical advantages. For example, the architecture of the present invention provides improved feature support during the switchover between two networks. The configuration of the present invention utilizes multiple calls to achieve this effect. An advantage of such a scheme is that if a call that is on HOLD is terminated, the phone would recognize this condition immediately. In previous scenarios, in order for the phone to understand this condition, it would need a signal from the enterprise network indicating that the non-active (HELD) call has gone away. In the case of a mobile phone, this signaling is normally done with dual tone multi-frequency (DTMF) codes, which are intrusive. Additionally, DTMF is not necessarily reliable in the opposite direction of communications. The present invention obviates this problem, and others, in effectively avoiding such undesired signaling. In a general sense, the present invention implicates multiple calls and, further, allows cellular features to be handled by the cellular network and the phone. The work that is performed by the cellular network and the phone in the present invention reduces the (otherwise present) signaling in the enterprise network. Hence, the present invention minimizes unnecessary disturbances, which in turn better accommodates the participating end user and enhances the end user's experience in the session.

Certain technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram that illustrates a communication system having elements that support a handoff between cellular and enterprise networks;

FIG. 2 is a block diagram illustrating functional components of a mobility application and a mobile station from the communication system; and

FIG. 3 is a simplified flowchart associated with a method for providing feature support in the communication system.

### DETAILED DESCRIPTION OF THE INVENTION

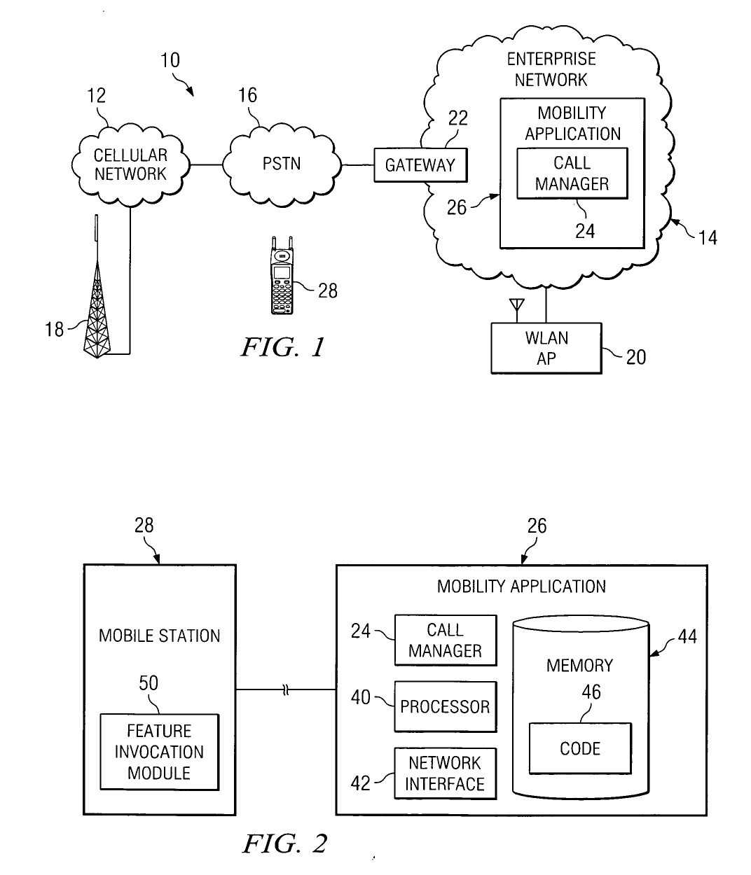

FIG. 1 is a simplified block diagram that illustrates a communication system 10 for providing feature support using multiple calls in a handoff environment. Communication system 10 comprises a cellular network 12 and an enterprise network 14, which are interconnected through a public switched telephone network (PSTN) 16. One or more base stations 18 are coupled to cellular network 12, and one or more access points 20 are coupled to enterprise network 14. Enterprise network 14 includes a gateway 22, a Call Manager 24 (that is manufactured by Cisco Systems, Inc. of San Jose, Calif.), and a mobility application 26, which can perform one or more operations associated with a handoff server.

Communication system 10 also includes mobile station 28, which may communicate with a remote device through cellular network 12 using base station 18 and/or through enterprise network 14 using a wireless local area network access point (WLAN AP) 20. The elements of communication system 10 can operate to permit mobile station 28 to maintain a communication session that is handed between cellular network 12 and enterprise network 14. According to particular embodiments, mobility application 26 and/or mobile station 28 utilize one or more of various private branch exchange (PBX) functions to effect handoff between cellular network 12 and enterprise network 14.

Prior to discussing the following FIGURES, the problems or situations that are being addressed by the proposed flows should be understood. Consider a call-waiting scenario, where an end user is already on a call on mobile station 28 and a second call comes in for the phone. In such a scenario, the end user has roamed from his enterprise network 14 to cellular network 12, which has picked up the call. The dilemma that is now presented relates to how to accommodate the call-waiting scenario in an optimal fashion.

Thus, a call associated with mobile station 28 is properly anchored by mobility application 26. In order to execute a handoff, a new cellular call must be made. Hence, mobile station 28 can make the cellular call over cellular network 12 and to mobility application 26, whereby a switch occurs over to that call leg. Mobility application 26 is handling multiple calls and multiple mobile stations.

When a call is placed, the call lands on mobility application 26, which recognizes, and is aware of, the call. Hence, when mobile station 28 moves to cellular network 12, mobility application 26 receives a “stealth call” from mobile station 28 and, in response to the stealth call, mobility application 26 collaborates with Call Manager 24 to switch (or to transfer [on the fly]) the call. In a similar, reciprocal fashion, when mobile station 28 moves back to enterprise network 14 it communicates with mobility application 26, which transfers the call from a cellular call leg to a voice over IP (VoIP) call leg.

One approach for feature support for mobile station 28 may be to anchor a call and provide (feature awareness) intelligence in the enterprise network to address this issue. Communication system 10 takes a different approach in offering an optimal solution that provides for an effective feature support mechanism. The present invention simulates features on mobile station 28 by having multiple cell calls to mobile station 28. Mobile station 28 would then be responsible for coordinating the media, for example by invoking cellular supplementary service, in order to make the feature work properly for the end user.

Hence, a second call is made to mobile station 28 and the call feature (in this case call-waiting) will be handled by mobile station 28 and cellular network 12. Mobile station 28 can then toggle between the two cell calls. The advantage of such a scheme is that if a call on HOLD is terminated, the phone would recognize this condition immediately. This stands in stark contrast to previous scenarios where mobile station 28 would need a signal from enterprise network 14 indicating that the non-active (HOLD) call has gone away. In the case of a mobile phone, this signaling is normally done with dual tone multi-frequency (DTMF) codes, which are intrusive. Additionally, DTMF is not necessarily reliable in the network to mobile direction of communications.

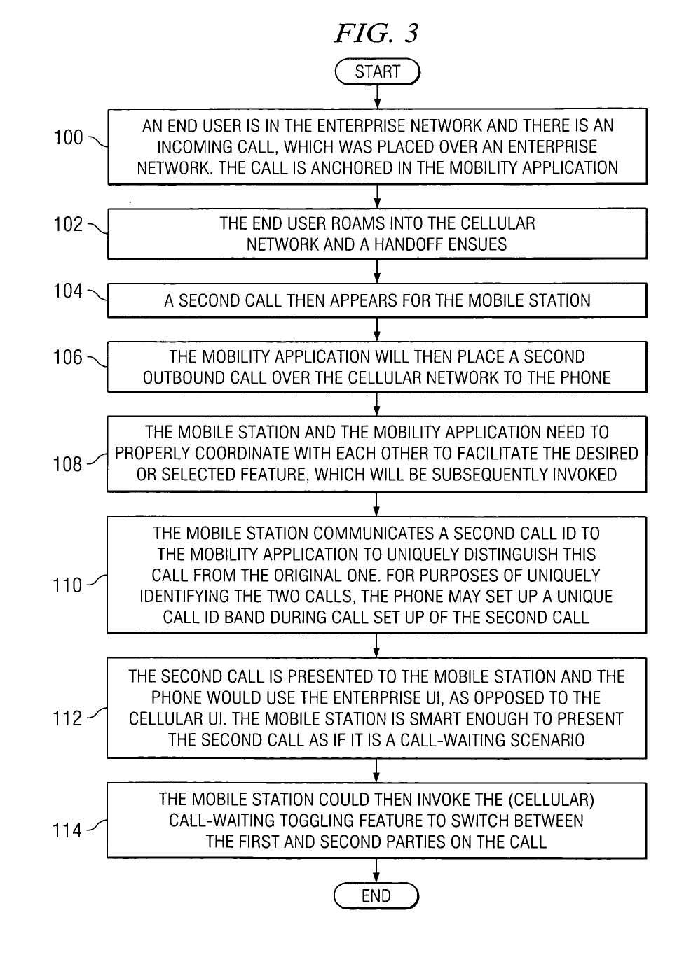

In a general sense, communication system 10 involves two calls and allows cellular features to be handled by cellular network 12 and mobile station 28. Work that is performed by cellular network 12 and mobile station 28 reduces the (otherwise present) signaling in enterprise network 14. At a higher level, it should be appreciated that at any given time, there is an active call and a number of passive calls. Any features that could reside in this passive mode (or held state) could readily be accommodated by the present invention, as the user can elect which feature to trigger. Additional details related to these operations are provided below with reference to FIGS. 2 and 3.

Cellular network 12 represents communications equipment, including hardware and any appropriate controlling logic, for providing wireless telephony services using cellular protocols and technology. Various cellular protocols and technologies may be used by cellular network 12, including but not limited to global system for mobile communications (GSM), time division multiple access (TDMA), code division multiple access (CDMA), and any other appropriate analog or digital cellular protocol or technology. Furthermore, cellular network 12 may utilize signaling system 7 (SS7) protocol for signaling purposes. Cellular network 12 may include any number of base stations 18, as well as base station controllers, mobile switching centers, and other appropriate communications equipment for use in communicating with mobile station 28 and PSTN 16. Thus, as illustrated, cellular network 12 may couple to base station 18 to receive and transmit wireless signals to and from mobile station 28.

Enterprise network 14 represents communications equipment, including hardware and any appropriate controlling logic, for interconnecting elements coupled to enterprise network 14. Thus, enterprise network 14 may represent a local area network (LAN), a wide area network (WAN), and/or any other appropriate form of network. Furthermore, elements within enterprise network 14 may utilize circuit-switched and/or packet-based communication protocols to provide for wireline telephony services. For example, elements within enterprise network 14 may utilize Internet Protocol (IP). In addition, elements within enterprise network 14 may utilize wireless standards such as the 802.11 family of wireless standards to provide for wireless telephony services. Note that the 802.11 family of wireless standards includes, among others, 802.11a, 802.11b, and 802.11g. Enterprise network 14 may also utilize interactive voice response (IVR). Enterprise network 14 may include any number of wireless network devices 20, gateways 22, Call Managers 24, and other appropriate communications equipment for use in communicating with mobile station 28 and PSTN 16. In the embodiment illustrated, enterprise network 14 includes access point 20, gateway 22, Call Manager 24, and mobility application 26. Access point 20 represents communications equipment, including hardware and any appropriate controlling logic, for providing wireless access to enterprise network 14. Access point 20 may utilize one or more of the 802.11 standards. However, any appropriate wireless standard or protocol may be used.

Gateway 22 represents communications equipment, including hardware and any appropriate controlling logic, for interconnecting enterprise network 14 with cellular network 12 and/or PSTN 16. Gateway 22 may be used to convert communications between different communication protocols. For example, gateway 22 may convert communications received from cellular network 12 in SS7 protocol to any of various other protocols that may be used by enterprise network 14, such as protocols associated with the an integrated services digital network (ISDN) standard in the case of circuit-switched trunking and H.323, session initiation protocol (SIP), or other appropriate protocols in the case of IP-based trunking.

Call Manager 24 represents communications equipment or a communications platform, including hardware and any appropriate controlling logic, for providing telephony services over enterprise network 14. For example, Call Manager 24 may support VoIP communications, using any of various protocols such as SIP, signaling connection control point (SCCP) protocol, media gateway control protocol (MGCP), H.323, and/or any other appropriate protocol for VoIP. Furthermore, Call Manager 24 may act as an IP PBX and support PBX functions, such as hold, park, transfer, redirect, and/or other high level and low level call management features.

Mobility application 26 represents a server in one embodiment of the present invention, but alternatively could be replaced with any other appropriate device (e.g. a router, switch, bridge, gateway, etc.) that facilitates the operations detailed herein. Mobility application 26 includes any suitable collection of hardware, software, and controlling logic to support a handoff between cellular network 12 and enterprise network 14 and to facilitate feature support, as outlined herein in this document. For example, mobility application 26 may, when appropriate, utilize PBX features to effect a handoff of a communication session between cellular network 12 and enterprise network 14.

It should also be noted that the internal structure of mobility application 26 and mobile station 28 are malleable and can readily be changed, modified, rearranged, or reconfigured in order to achieve their intended operations as they pertain to the handoff function and the feature support/feature invocation. Software and/or hardware may reside in these elements (or in just one) in order to achieve the teachings of the media handling features of the present invention. Hence, software and/or hardware is provided in mobile station 28, which knows how to invoke cellular features (e.g. HOLD, resume, retrieve, call-waiting, conferencing, transfer, caller-ID, (advanced) display functions, redirect, three-way calling, barging operations, etc.). This feature knowledge is present when mobile station 28 is on cellular network 12. Mobile station 28 also performs general feature invocation when it is on enterprise network 14 (e.g. VoIP network). In addition, modifications/enhancements to mobility application 26 could also be provided in order to offer both (or multiple) calls to mobile station 28.

However, due to their flexibility, these elements (mobility application 26 and mobile station 28) may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structures of mobility application 26 and mobile station 28 in the context of communication system 10 and, accordingly, they should be construed as such.

PSTN 16 represents communications equipment, including hardware and any appropriate controlling logic, through which cellular network 12 and enterprise network 14 may communicate. PSTN 16 may include switches, wireline and wireless communication devices, and any other appropriate equipment for interconnecting cellular network 12 and enterprise network 14. PSTN 16 may include portions of public and private networks providing network transport services between various geographic areas and networks.

Mobile station 28 represents a mobile device, including hardware and any appropriate controlling logic, capable of communicating with remote devices through cellular network 12 and enterprise network 14 and maintaining communication sessions with remote devices during handoff between cellular network 12 and enterprise network 14. Mobile station 28 may communicate through cellular network 12 using base station 18 and through enterprise network 14 using access point 20. Furthermore, mobile station 28 may interact with Call Manager 24 and/or mobility application 26 when appropriate to utilize PBX features to effect a handoff between cellular network 12 and enterprise network 14.

In operation, mobile station 28 may initiate and receive telephone calls through cellular network 12 and/or enterprise network 14 to establish communication sessions with remote devices. Note that, as used herein, a remote device refers to any communications device capable of establishing communications sessions with mobile station 28, such as devices located in cellular network 12, enterprise network 14, PSTN 16, or other linked networks. Furthermore, as used herein, a communication session refers to the transfer of voice, video, data, and/or other information between two or more communication devices. For example, according to particular embodiments a communication session may involve a call between two communication devices or a conference call involving two or more communication devices.

At any point in time, mobile station 28 may determine to handoff a communication session from cellular network 12 to enterprise network 14 or from enterprise network 14 to cellular network 12. For example, after establishing a communication session, mobile station 28 may lose or begin to lose connectivity with base station 18 or WLAN access point 20. Signal degradation may occur due to various causes. For example, mobile station 28 may begin to lose wireless connectivity due to physical movement. When possible, mobile station 28 may switch between using base station 18 and WLAN access point 20 for communications. Moreover, in certain circumstances mobile station 28 may maintain a communication session during handoff between cellular network 12 and enterprise network 14.

Handoff may occur when mobile station 28 travels from an area serviced by cellular network 12 to an area serviced by enterprise network 14. Handoff may also occur in the opposite direction, when mobile station 28 travels from an area serviced by enterprise network 14 to an area serviced by cellular network 12. However, handoff may occur at any other appropriate time. For example, handoff may occur when mobile station 28 is located in an area serviced by both network types due to a predetermined preference of one type of network, due to a spontaneous choice of a user of mobile station 28, or in response to analyzing error rates or other data associated with signaling provided by one or both types of networks. For example, error rates may be associated with signal strengths of base station 18 and access point 20, and may be dependent upon a location of mobile station 28.

After receiving a telephone call intended for mobile station 28, Call Manager 24 and/or mobility application 26 may include itself in a signaling path associated with the resulting communication session, whether the signaling path proceeds through cellular network 12 or enterprise network 14.

Note that communication system 10 represents only one embodiment of a system that supports handoff between cellular and enterprise wireless networks. Various alternative embodiments are possible. For example, while in the illustrated embodiment enterprise network 14 couples to cellular network 12 through PSTN 16 using gateway 22, various other embodiments may include enterprise network 14 coupling to cellular network 12 in other ways. For example, enterprise network 14 may couple to cellular network 12 using a service provider that supports VoIP. Thus, in alternative embodiments, cellular network 12 and gateway 22 may not be included in communication system 10.

FIG. 2 is a block diagram illustrating functional components of mobility application 26 and mobile station 28. In the embodiment illustrated, mobility application 26 includes Call Manager 24, as well as a processor 40, a network interface 42, and a memory 44. Mobile station 28 includes a feature invocation module 50 in this particular embodiment. These functional elements can operate to support a handoff of active communication sessions when mobile station 28 roams between cellular network 12 and enterprise network 14. These elements can also facilitate the feature support operations as outlined herein in this document.

Feature invocation module 50 knows how to invoke cellular features (e.g. HOLD, resume, retrieve, call-waiting, conferencing, transfer, redirect, three-way calling, etc.), as the end user desires. This ability or feature knowledge is present when mobile station 28 is on cellular network 12. Mobile station 28 also performs general feature invocation when it is on enterprise network 14.

Processor 40 controls the operation and administration of elements within mobility application 26. For example, processor 40 operates to process information received from network interface 42 and memory 44. Processor 40 includes any hardware and/or logic elements operable to control and process information. For example, processor 40 may be a programmable logic device, a microcontroller, a microprocessor, and/or any other suitable processing device.

Network interface 42 communicates information to and receives information from devices coupled to enterprise network 14. For example, network interface 42 may communicate with gateway 22, Call Manager 24, and access point 20. Furthermore, network interface 42 may receive information from and transmit information to remote devices as well as mobile station 28. Thus, network interface 42 includes any suitable hardware or controlling logic used to communicate information to or from elements coupled to mobility application 26.

Memory 44 stores, either permanently or temporarily, data and other information for processing by processor 40 and communication using network interface 42. Memory 44 includes any one or a combination of volatile or nonvolatile local or remote devices suitable for storing information. For example, memory 44 may include random access memory (RAM), read only memory (ROM), magnetic storage devices, optical storage devices, or any other suitable information storage device or a combination of these devices. As illustrated, memory 44 may include one or more memory modules, such as code 46.

Code 46 includes software, executable files, and/or appropriate logic modules capable when executed to control the operation of mobility application 26. For example, code 46 may include executable files capable of supporting handoff between cellular network 12 and enterprise network 14. Code 46 may include instructions to enable mobility application 26 to utilize PBX features. In addition, code 46 could also be provided in order to offer both (or multiple) calls to mobile station 28, as outlined herein.

In operation, network interface 42 may receive an indication from mobile station 28 that mobile station 28 intends to utilize a second network, for example cellular network 12. In some embodiments, processor 40 may communicate a handoff number to mobile station 28 through network interface 42.

Note that mobility application 26 may use any appropriate protocol to communicate with other elements of communication system 10. For example, mobility application 26 may utilize Java telephony application programming interface (JTAPI) to interact with Call Manager 24.

While this example includes specific functional components for mobility application 26 and mobile station 28, these elements may include any collection and arrangement of components, including some or all of the enumerated functional components, for supporting feature invocation. Moreover, mobility application 26 contemplates implementing each of the functional components using any suitable combination and arrangement of hardware and/or logic, and implementing any of the functionalities using a computer program stored on a computer-readable medium. Furthermore, mobility application 26 may be implemented as a stand-alone device, or aspects of mobility application 26 may be distributed among various devices within enterprise network 14. Alternatively, in some embodiments mobility application 26 may be incorporated into Call Manager 24.

Turning now to FIG. 3, FIG. 3 is a simplified flowchart associated with a method for provided feature support in communication system 10. In operation of an example flow, consider an example where an end user is in enterprise network 14 and there is an incoming call, which was placed over a VoIP network (i.e. enterprise network 14). This call is anchored in mobility application 26 (i.e. enterprise network 14). This is illustrated by step 100. At step 102, the end user roams into cellular network 12 and a handoff ensues. The call is handed off, as opposed to just handing off mobile station 28. The difference is that on a single phone, depending on the feature, there could be multiple calls (e.g. one being active, one being passive, etc.). For instance, in a call-waiting scenario or in setting up a three-way call, one person may be involved in the call, whereas another is on HOLD.

Continuing with the example, at step 104, a second call then appears for mobile station 28. Mobility application 26 will then place a second outbound call over cellular network 12 to the phone. This is illustrated by step 106. At this point, mobile station 28 and mobility application 26 need to properly coordinate with each other to facilitate the desired or selected feature, which will be subsequently invoked. This is illustrated by step 108. At step 110, mobile station 28 communicates a second call ID to mobility application 26 to uniquely distinguish this call from the original one. For example, if the first call had an ID of one (1) and the second call ID was two (2), the phone could use in-band DTMF (or any other signaling means) to communicate back ‘02’ when the second call came in. In alternative scenarios, the call ID could simply be passed in-band. For purposes of uniquely identifying the two calls, the phone may set up a unique call ID during call set-up of the second call.

Returning to the example of FIG. 3, at step 112 the second call is presented to mobile station 28 and the phone can use the enterprise UI, as opposed to the cellular UI. Mobile station 28 is smart enough to present the second call as if it is a call-waiting scenario. It could preserve the same UI as it does in the enterprise network, but this does not necessarily have to be the case. Mobile station 28 could then invoke the (cellular) call-waiting toggling feature to switch between the first and the second parties on the call. This is illustrated in step 114.

Consider a case where, from this point, the end user (having both calls up) ventures back into enterprise network 14. Both calls need to be handed off in such a scenario. This is where the unique ID, which was exchanged during call set-up (e.g. using in-band DTMF), is used to identify the two calls. So a handoff request, which includes this ID that identifies the call, is sent to mobility application 26. Mobility application 26 would then be able to accommodate both calls in this scenario. Two calls are now present and functional: one call is active and the other is on HOLD. The IDs allow mobility application 26 to properly connect the calls.

Note that while the preceding examples include specific functional components for mobile station 28, mobile station 28 may include any collection and arrangement of components, including some or all of the enumerated functional components, for communicating with remote devices using cellular network 12 and/or enterprise network 14 and effecting a handoff between cellular network 12 and enterprise network 14. Moreover, mobile station 28 contemplates implementing each of the functional components using any suitable combination and arrangement of hardware and/or logic. Thus, in one embodiment mobile station 28 is a mobile phone. In other embodiments, mobile station 28 may be a personal digital assistant (PDA), any type of telephone, an electronic notebook, a laptop computer, or any other device operable to establish communications with cellular network 12 and enterprise network 14.

The preceding discussions illustrate particular methods for effecting handoff between cellular network 12 and enterprise network 14 and for providing appropriate feature support. However, these discussions illustrate only exemplary methods of operation. While discussions often focus on handoff in the enterprise-to-cellular direction, similar techniques may be used to provide for feature support in the cellular-to-enterprise direction. Furthermore, communication system 10 contemplates devices using any suitable techniques, elements, and applications for performing these functions. Thus, many of the steps in the discussions may take place simultaneously and/or in different orders than as shown. In addition, the devices may use methods with additional steps or fewer steps, so long as the methods remain appropriate. Moreover, other devices of communication system 10 may perform similar techniques to support feature invocation and handoffs between cellular network 12 and enterprise network 14.

It is critical to note that the stages and steps in the FIGURES illustrate only some of the possible scenarios and operations that may be executed by, or within, the present system. Some of these stages and/or steps may be deleted or removed where appropriate, or these stages and/or steps may be modified, enhanced, or changed considerably without departing from the scope of the present invention. In addition, a number of these operations have been described as being executed concurrently with, or in parallel to, one or more additional operations. However, the timing of these operations may be altered. The preceding example flows have been offered for purposes of teaching and discussion. Substantial flexibility is provided by the tendered architecture in that any suitable arrangements, chronologies, configurations, and timing mechanisms may be provided without departing from the broad scope of the present invention. Accordingly, communications capabilities, data processing features and elements, suitable infrastructure, and any other appropriate software, hardware, or data storage objects may be included within communication system 10 to effectuate the tasks and operations of the elements and activities associated with executing suitable feature support functions.

Although the present invention has been described in detail with reference to particular embodiments, it should be understood that various other changes, substitutions, and alterations may be made hereto without departing from the spirit and scope of the present invention. The illustrated network architecture of FIG. 1 has only been offered for purposes of example and teaching. Suitable alternatives and substitutions are envisioned and contemplated by the present invention: such alternatives and substitutions being clearly within the broad scope of communication system 10. For example, the use of gateway 22 could be supplanted by bridges, switches, routers or any other suitable devices that are conducive to network communications. In addition the use of DTMF is only one example signaling protocol. DTMF can be supplanted with SMS or any other signaling channel that is available in the cellular or PSTN network. In still other embodiments, signaling may be achieved in-band or out-of-band where appropriate.

Note that the present invention could also readily be used in cases where a new call is initiated when the mobile station is in the cellular network. The use of multiple calls for enterprise feature support would still apply: even though no handoff has taken place.

Numerous other changes, substitutions, variations, alterations, and modifications may be ascertained to one skilled in the art and it is intended that the present invention encompass all such changes, substitutions, variations, alterations, and modifications as falling within the spirit and scope of the appended claims.

What is claimed is:

1. An apparatus for providing feature support, comprising:
a mobile station operable to receive multiple cell calls and to coordinate media in order to make a feature of the mobile station functional for an end user of the mobile station, wherein the feature is invoked after the mobile station has roamed from an enterprise network to a cellular network and experienced a handoff.

2. The apparatus of claim 1, wherein if any of the calls are terminated, the mobile station is made aware of the termination.

3. The apparatus of claim 1, wherein the feature is a selected one of a group of features, the group consisting of:
1) HOLD;
2) resume;
3) retrieve;
4) call-waiting;
5) conferencing;
6) transfer;
7) caller ID;
8) redirect;
9) three-way calling; and
10) barging operations.

4. The apparatus of claim 1, wherein the mobile station is operable to communicate with a mobility application to achieve the handoff, and wherein the mobile station is further operable to communicate a call ID to the mobility application to uniquely distinguish a second call from a first call, which was an original call for the mobile station.

5. The apparatus of claim 1, wherein the mobile station is operable to uniquely identify a first call and a second call by establishing a unique call ID during call set-up of the second call received by the mobile station.

6. The apparatus of claim 5, wherein the unique call ID leverages dual tone multi-frequency (DTMF) codes.

7. The apparatus of claim 5, wherein the unique call ID is executed in-band.

8. The apparatus of claim 1, wherein the mobile station is operable to hand off the calls when it roams from the cellular network and back into the enterprise network.

9. A method for providing feature support, comprising:
receiving, by a mobile station, multiple cell calls; and
coordinating media associated with the cell calls in order to make a feature of the mobile station functional for an end user of the mobile station, wherein the feature is invoked after the mobile station has roamed from an enterprise network to a cellular network and experienced a handoff.

10. The method of claim 9, wherein if any of the calls are terminated, the mobile station is made aware of the termination.

11. The method of claim 9, further comprising:
communicating with a mobility application to achieve the handoff; and
communicating a call ID to the mobility application to uniquely distinguish a second call from a first call, which was an original call for the mobile station.

12. The method of claim 9, further comprising:
uniquely identifying a first call and a second call by establishing a unique call ID during call set-up of the second call received by the mobile station.

13. The method of claim 12, wherein the unique call ID leverages dual tone multi-frequency (DTMF) codes.

14. The method of claim 12, wherein the unique call ID is executed in-band.

15. The method of claim 9, further comprising:
handing off the calls when the mobile station roams from the cellular network and back into the enterprise network.

16. Software for providing feature support, the software being embodied in a computer readable medium and comprising computer code such that when executed is operable to:
receive multiple cell calls; and
coordinate media associated with the cell calls in order to make a feature of a mobile station functional for an end user of the mobile station, wherein the feature is invoked after the mobile station has roamed from an enterprise network to a cellular network and experienced a handoff.

17. The medium of claim 16, wherein if any of the calls are terminated, the mobile station is made aware of the termination.

18. The medium of claim 16, wherein the code is further operable to:
communicate with a mobility application to achieve the handoff; and
communicate a call ID to the mobility application to uniquely distinguish a second call from a first call, which was an original call for the mobile station.

19. The medium of claim 16, wherein the code is further operable to:
uniquely identify a first call and a second call by establishing a unique call ID during call set-up of the second call received by the mobile station.

20. The medium of claim 16, wherein the code is further operable to:
hand off the calls when the mobile station roams from the cellular network and back into the enterprise network.

21. An apparatus for providing feature support, comprising:
a mobile station operable to receive multiple cell calls and to coordinate media in order to make a feature of the mobile station functional for an end user of the mobile station, wherein the feature is invoked when the mobile station is in a cellular network.

22. The apparatus of claim 21, wherein if any of the calls are terminated, the mobile station is made aware of the termination.

23. The apparatus of claim 21, wherein the feature is a selected one of a group of features, the group consisting of:
1) HOLD;
2) resume;
3) retrieve;
4) call-waiting;
5) conferencing;
6) transfer;
7) caller ID;
8) redirect;
9) three-way calling; and
10) barging operations.

24. The apparatus of claim 21, wherein the mobile station is operable to communicate with a mobility application, and wherein the mobile station is further operable to communicate a call ID to the mobility application to uniquely distinguish a second call from a first call, which was an original call for the mobile station.

25. The apparatus of claim 21, wherein the mobile station is operable to uniquely identify a first call and a second call by establishing a unique call ID during call set-up of the second call received by the mobile station.

26. The apparatus of claim 25, wherein the unique call ID leverages dual tone multi-frequency (DTMF) codes.

27. The apparatus of claim 25, wherein the unique call ID is executed in-band.
